(19) United States
(12) Patent Application Publication
(10) Pub. No.: US 2008/0119580 A1
(43) Pub. Date: May 22, 2008

(54) THERMOSETTING COATING COMPOSITIONS WITH THREE OR MORE CURE MECHANISMS

(76) Inventors: Gregory G. Menovcik, Northville, MI (US); Walter H. Ohrbom, Hartland Township, MI (US); Timothy S. December, Rochester Hills, MI (US)

Correspondence Address: BASF CORPORATION;Patent Department, 1609 BIDDLE AVENUE, MAIN BUILDING, WYANDOTTE, MI, 48192, US

(21) Appl. No.: 11/560,944

(22) Filed: Nov. 17, 2006

(51) Int. Cl. C08F 2/46; C08F 8/00

(52) U.S. Cl. 522/46; 525/50; 525/326.1; 525/474; 525/452; 525/509

(57) ABSTRACT

Thermosetting coating compositions contain crosslinkable materials, which may be selected from polymers, oligomers, or monomeric compounds, that have at least two, preferably at least three crosslinkable functional groups and crosslinkers selected from crosslinking materials, which may also be selected from polymers, oligomers, or monomeric compounds, that have functional groups reactive with the crosslinkable functional groups of the crosslinkable materials and, optionally, may also include photoinitiators that, on exposure to actinic radiation, initiate addition polymerization of crosslinkable functional groups of the crosslinkable materials, so that the crosslinkable functional groups and the crosslinkers have at least three kinds of mutually reactive combinations.

### FIELD OF THE INVENTION

The invention relates to thermosetting coating compositions, materials therefor, and methods of making and using such coatings compositions.

### BACKGROUND OF THE INVENTION

Curable, or thermosettable, coating compositions are widely used in the coatings art, particularly for topcoats in the automotive and industrial coatings industry. Color-plus-clear composite coatings provide topcoats with exceptional gloss, depth of color, distinctness of image, and special metallic effects. The automotive industry has made extensive use of these coatings for automotive body panels. A topcoat coating should be durable to maintain its appearance and provide protection under service conditions during the lifetime of the coated article. Topcoat coatings for automotive vehicles, for example, are typically exposed to all kinds of weather, ultraviolet rays from the sun, abrasions from gravel thrown up during driving or from items set on the car when parked, and other conditions that can degrade the coating. For some time, researchers have directed their efforts to providing coatings with greater resistance to environmental etch. “Environmental etch” is a term applied to a kind of exposure degradation that is characterized by spots or marks on or in the finish of the coating that often cannot be rubbed out.

Curable coating compositions utilizing carbamate-functional resins are described, for example, in U.S. Pat. Nos. 5,693,724, 5,693,723, 5,639,828, 5,512,639, 5,508,379, 5,451,656, 5,356,669, 5,336,566, and 5,532,061, each of which is incorporated herein by reference. These coating compositions can provide significant improvements in resistance to environmental etch over other coating compositions, such as hydroxy-functional acrylic/melamine coating compositions. On the other hand, carbamate-functional resins tend to require more organic solvent to achieve acceptable viscosity for application and leveling of the applied film to obtain desired smoothness. Coatings with higher amounts of organic solvent produce more regulated emissions during application. Coatings with hydroxyl-functional acrylic polymers cured using blocked polyisocyanate can also provide excellent resistance to environmental etch in cured coatings, but these coatings do not have the desired scratch and mar resistance. Coatings with hydroxyl-functional acrylic polymers cured using aminoplasts can be formulated at higher solids and cured at lower temperatures relative to the other compositions mentioned, but do not provide the environmental etch resistance or scratch and mar resistance of the other coatings. Other coating chemistries have been used, but these also have shortcomings, such as poor weathering properties or high volatile organic content [VOC].

U.S. Pat. Nos. 5,693,724, 5,693,723, 5,639,828, 5,512,639, 5,508,379, 5,451,656, 5,356,669, 5,336,566, 5,532,061 and 6,531,560 describe incorporating carbamate functionality by ‘trans-carbamating’ hydroxyl-functional acrylic resins. The reaction step is a time-consuming process, however, and produces side products like methanol that, along with other solvents used for the reaction medium, must be removed somehow. Also, the resulting resin is a higher viscosity solution due to presence of carbamate groups, resulting in lower paint solids and higher VOCs.

It would be advantageous to have a coating composition that could provide desired environmental etch resistance and improved scratch and mar resistance without dramatically increasing the viscosity of the coating composition.

### SUMMARY OF THE INVENTION

We provide thermosetting coating compositions containing crosslinkable materials, which may be selected from polymers, oligomers, or monomeric compounds, that have at least two, preferably at least three crosslinkable functional groups and crosslinkers selected from crosslinking materials, which may also be selected from polymers, oligomers, or monomeric compounds, that have functional groups reactive with the crosslinkable functional groups of the crosslinkable materials and, optionally, may also include photoinitiators that, on exposure to actinic radiation, initiate addition polymerization of crosslinkable functional groups of the crosslinkable materials, so that the crosslinkable functional groups and the crosslinkers have at least three kinds of mutually reactive combinations.

In a further embodiment, at least a first crosslinkable material has two kinds of crosslinkable functional groups and at least a second crosslinkable material has a third kind of crosslinkable functional group different from the crosslinkable functional groups of the first crosslinkable material.

In another embodiment, each crosslinking material has only one kind of functional groups reactive with only one kind of the crosslinkable functional groups of the crosslinkable materials to form a bond that is thermally irreversible under the curing conditions.

In still another embodiment, each crosslinking material has at least two kinds of functional groups reactive with at least two kinds of the crosslinkable functional groups of the crosslinkable materials to form a bond that is thermally irreversible under the curing conditions.

In yet another embodiment, one crosslinking material has functional groups reactive with at least three kinds of the crosslinkable functional groups of the crosslinkable materials to form a bond that is thermally irreversible under the curing conditions. The functional groups of the crosslinking material may be all of the same kind or may a combination of two or more kinds.

Further provided are coatings and coated articles prepared by applying the described thermosetting coating composition onto an article and curing the applied coating composition to form a cured coating layer on the article.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring such parameters.

### DETAILED DESCRIPTION OF THE PREFERRED EMBODIMENTS

The following description of the preferred embodiment(s) is merely exemplary in nature and is in no way intended to limit the invention, its application, or uses.

The thermosetting coating compositions contain crosslinkable materials, which may be selected from polymers, oligomers, or monomeric compounds, that have at least two, preferably at least three crosslinkable functional groups. Nonlimiting examples of polymers and oligomers that may be utilized are vinyl polymers such as acrylic polymers, including those that are modified by reaction of hydroxyl groups with epsilon-caprolactone; polyesters, including those based on lactones such as polycaprolactone or polyethers such as polyethylene oxide; alkyds; polyurethanes, including those prepared using polyester polyols; polyurethane- or polyester-modified acrylic polymers and other vinyl polymers, epoxy resins, polycarbonates, polyamides, polysiloxanes, polyethylenically unsaturated oligomers, including acrylate esters of polyols and polyepoxides, and combinations of these. The crosslinkable materials may also comprise one or more monomeric compounds that have at least two, and preferably three crosslinkable functional groups. Such compounds may also have internal urethane, ester, ether, or other linking moieties. Nonlimiting examples of crosslinkable functional groups that may be on the crosslinkable materials include hydroxyl groups, carboxyl groups, epoxide groups, amino groups, amido groups carbamate groups, urea groups, ethylenically unsaturated carbon bonds, isocyanate groups, silane groups, silanol groups, cyclic carbonate groups, and combinations of these. A carbamate group has a structure

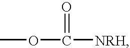

in which R is H or alkyl. Preferably, R is H or alkyl of from 1 to about 4 carbon atoms, and more preferably R is H.

In one embodiment, the crosslinkable materials include an acrylic or vinyl polymer having one or more kinds of crosslinkable functional groups. The desired functionality is usually introduced to the vinyl or acrylic polymer by copolymerizing a monomer having that functionality, but the functionality may also be added after the polymerization reaction, as in the case of hydrolysis of vinyl acetate groups to hydroxyl. Examples of functional monomers include, without limitation, hydroxyl-functional monomers such as hydroxyethyl acrylate, hydroxypropyl acrylate, hydroxybutyl acrylates, hydroxyethyl methacrylate, hydroxypropyl methacrylate, hydroxybutyl methacrylates, carbamate-functional monomers such as the reaction product of a hydroxyalkyl carbamate with acrylic or methacrylic acid or the reaction product of glycidyl carbonate with acrylic or methacrylic acid, followed by reaction of the carbonate group with ammonia or a primary amine, amine-functional monomers such as aminomethyl, aminopropyl, aminobutyl and aminohexyl acrylates and methacrylates such as t-butylaminoethyl methacrylate, dimethylaminoethyl acrylate, and dimethylaminoethyl methacrylate, epoxide-functional monomers such as glycidyl acrylate, glycidyl methacrylate, allyl glycidyl ether, carboxyl-functional monomer such as acrylic acid, methacrylic acid, crotonic acid, itaconic acid, maleic acid, fumaric acid, 2-acryloxymethoxy-O-phthalic acid, 2-acryloxy-1-methylethoxy-O-hexahydrophthalic acid, anhydride-functional monomers such as maleic anhydride, itaconic anhydride, isocyanate-functional monomers such as isocyanatoethyl methacrylate, 1-(1-isocyanato-1-methylethyl)-3-(1-methylethyenyl)benzene, silane containing monomers, including alkoxysilane functional monomers, such as gamma-methylacryloxy propyl-trimethoxy silane, gamma-methylacryloxypropyl-triethoxy silane, gamma-methylacryloxypropyl-triisopropoxy silane, silanol functional-monomer such as those produced by hydrolysis of a silane functional monomer, other monomers with reactive groups such as N-alkoxymethylacrylamide, and N-(butoxymethyl)acrylamide, and so on. Isocyanate groups may be blocked before polymerization of the monomer if desired, but the blocking can be done at any point.

The acrylic or vinyl polymers may be polymerized using one or more further comonomers. Examples of such comonomers include, without limitation, esters of α,β-ethylenically unsaturated monocarboxylic acids containing 3 to 5 carbon atoms such as acrylic, methacrylic, and crotonic acids and of α,β-ethylenically unsaturated dicarboxylic acids containing 4 to 6 carbon atoms; vinyl esters, vinyl ethers, vinyl ketones, and aromatic or heterocyclic aliphatic vinyl compounds. Representative examples of suitable esters of acrylic, methacrylic, and crotonic acids include, without limitation, those esters from reaction with saturated aliphatic and cycloaliphatic alcohols containing 1 to 20 carbon atoms, such as methyl, ethyl, propyl, isopropyl, n-butyl, isobutyl, tert-butyl, 2-ethylhexyl, lauryl, stearyl, cyclohexyl, trimethylcyclohexyl, tetrahydrofurfuryl, stearyl, sulfoethyl, and isobomyl acrylates, methacrylates, and crotonates. Representative examples of other ethylenically unsaturated polymerizable monomers include, without limitation, such compounds as dialkyl fumaric, maleic, and itaconic esters, prepared with alcohols such as methanol, ethanol, propanol, isopropanol, butanol, isobutanol, and tert-butanol. Representative examples of polymerization vinyl monomers include, without limitation, such compounds as vinyl acetate, vinyl propionate, vinyl ethers such as vinyl ethyl ether, vinyl and vinylidene halides, and vinyl ethyl ketone. Representative examples of aromatic or heterocyclic aliphatic vinyl compounds include, without limitation, such compounds as styrene, alpha.-methyl styrene, vinyl toluene, tert-butyl styrene, and 2-vinyl pyrrolidone. The comonomers may be used in any combination.

The acrylic polymers may be prepared using conventional techniques, such as by heating the monomers in the presence of a polymerization initiating agent and optionally chain transfer agents. The polymerization is preferably carried out in solution, although it is also possible to polymerize the acrylic polymer in bulk. Suitable polymerization solvents include, without limitation, esters, ketones, ethylene glycol monoalkyl ethers and propylene glycol monoalkyl ethers, alcohols, and aromatic hydrocarbons.

Typical initiators are organic peroxides such as dialkyl peroxides such as di-t-butyl peroxide, peroxyesters such as t-butyl peroctoate and t-butyl peracetate, peroxydicarbonates, diacyl peroxides, hydroperoxides such as t-butyl hydroperoxide, and peroxyketals; azo compounds such as 2,2′azobis(2-methylbutanenitrile) and 1,1′-azobis(cyclohexanecarbonitrile); and combinations of these. Typical chain transfer agents are mercaptans such as octyl mercaptan, n- or tert-dodecyl mercaptan; halogenated compounds, thiosalicylic acid, mercaptoacetic acid, mercaptoethanol, and dimeric alpha-methyl styrene.

The solvent or solvent mixture is generally heated to the reaction temperature and the monomers and initiator(s) and optionally chain transfer agent(s) are added at a controlled rate over a period of time, typically from about two to about six hours. The polymerization reaction is usually carried out at temperatures from about 20° C. to about 200° C. The reaction may conveniently be done at the temperature at which the solvent or solvent mixture refluxes, although with proper control a temperature below the reflux may be maintained. The initiator should be chosen to match the temperature at which the reaction is carried out, so that the half-life of the initiator at that temperature should preferably be no more than about thirty minutes, more preferably no more than about five minutes. Additional solvent may be added concurrently. The mixture is usually held at the reaction temperature after the additions are completed for a period of time to complete the polymerization. Optionally, additional initiator may be added to ensure complete conversion of monomers to polymer.

The vinyl polymers may have a weight average molecular weight of 1500 to 100,000, preferably 1500 to 6000. Weight average molecular weight may be determined by gel permeation chromatography using polystyrene standard.

Polyester resins may be formulated as acid-functional or hydroxyl-functional resins. The polyester may have an acid number of from about 20 to about 100, preferably from about 20 to about 80, and more preferably from about 20 to about 40 mg KOH per gram. In another embodiment, the polyester may have a hydroxyl number of from about 25 to about 300, preferably from about 25 to about 150, and more preferably from about 40 to about 100 mg KOH per gram. The methods of making polyester resins are well-known. Typically, a polyol component and an acid and/or anhydride component are heated together, optionally with a catalyst, and usually with removal of the by-product water in order to drive the reaction to completion. The polyol component has an average functionality of at least about two. The polyol component may contain mono-functional, di-functional, tri-functional, and higher functional alcohols. Diols are preferred, but when some branching of the polyester is desired, higher functionality alcohols are included. Illustrative examples include, without limitation, alkylene glycols and polyalkylene glycols such as ethylene glycol, propylene glycol, diethylene glycol, triethylene glycol, and neopentyl glycol,; 1,4-butanediol, 1,6-hexanediol, 1,4-cyclohexane dimethanol, glycerine, trimethylolpropane, trimethylolethane, pentaerythritol, 2,2,4-trimethyl-1,3-pentanediol, hydrogenated bisphenol A, and hydroxyalkylated bisphenols. The acid and/or anhydride component comprises compounds having on average at least two carboxylic acid groups and/or anhydrides of these. Dicarboxylic acids or anhydrides of dicarboxylic acids are preferred, but higher functional acid and anhydrides can be used when some branching of the polyester is desired. Suitable polycarboxylic acid or anhydride compounds include, without limitation, those having from about 3 to about 20 carbon atoms. Illustrative examples of suitable compounds include, without limitation, phthalic acid, isophthalic acid, terephthalic acid, hexahydrophthalic acid, tetrahydrophthalic acid, pyromellitic acid, succinic acid, azeleic acid, adipic acid, 1,4-cyclohexanedicarboxylic acid, dodecane-1,12-dicarboxylic acid, citric acid, trimellitic acid, and anhydrides thereof.

Examples of useful epoxy resins are those having an epoxide equivalent weight of from about 500 to about 2000, preferably from about 600 to about 1000. Illustrative examples of useful epoxy resins include, without limitation, bisphenol A type resins, bisphenol F type resins, novolac epoxy resin, and alicyclic epoxy resins.

Polyurethanes useful as the polymer in the present compositions can be prepared, for example, by reacting polyisocyanate and polyol with an OH:NCO equivalent ratio of greater than 1:1, to obtain polyurethanes with terminal hydroxyl functionality. In this case, capping of the isocyanate occurs simultaneously with the synthesis of the polyurethane resin. Alternatively, polyurethane may be formed by reacting polyisocyanate and polyol with an OH:NCO ratio of less than 1:1. In this case, where excess isocyanate is used, the polyurethane having an unreacted isocyanate functionality is then reacted with a capping agent. Suitable capping agents include reactive alcohols or amines, by way of non-limiting example. Non-limiting examples of these are trimethylolpropane, ethanolaamine, diethanolamine, Solketal, diols, triols, or a mixture of diols and triols. Preferably, any unreacted isocyanate is removed before using the polyurethane as the polymer.

A functionality may be adducted onto a polymer by reaction of functional groups such as any of those already with a reactant having one type of group reactive therewith and a second group that is the desired functionality being added to the polymer. The desired group may even be the same as the original functionality on the polymer, such as reaction of hydroxyl group with epsilon-caprolactone. The desired functionality may also arise as a result of the reaction, such as reaction of an acid group on the polymer with an epoxide, which produces a hydroxyl group or reaction of a cyclic anhydride with a hydroxyl group, which produces a carboxyl group. Other examples include the conversion of a hydroxy group to a carbamate group by techniques known in the art, such as transcarbamation, urea decomposition, reaction with phosgene and then ammonia, and so on. A desired functionality may also be adducted onto a polymer or oligomer after the polymerization reaction. In certain preferred embodiments, such adductions are carried out only partially so that the product oligomer or polymer bears both the original functionality and the functionality being adducted on.

Crosslinkable materials including additional polymerizable groups include, without limitation, epoxy acrylate, urethane acrylate, and polyester acrylate oligomers, as well as the addition polymerizable monomers already mentioned above (particularly, the acrylate monomers). Nonlimiting examples of such oligomers include trimethylolpropane triacrylate, hexanediol diacrylate, the reaction products of hydroxyalkyl acrylate with a monomeric or oligomeric polyisocyanate or the reaction product of acrylic acid with triglycidyl isocyanurate (in which case the final product has two kinds of crosslinkable groups, hydroxyl and acrylate).

The coating composition may also includes a compound having acid and carbamate groups. The compound preferably is the reaction product of a hydroxy carbamate compound with an acid anhydride, resulting in one acid group for every carbamate group.

In particular, the compound having acid and carbamate groups may be a reaction product of a cyclic carboxylic acid anhydride compound and an hydroxyalkyl carbamate. Examples of suitable anhydrides compounds include, without limitation, phthalic anhydride, tetrahydrophthalic anhydride, succinic anhydride, maleic anhydride, trimellitic anhydride, pyromellitic anhydride, hexahydrophthalic anhydride, dodecenylsuccinic anhydride, and adipic anhydride. Examples of suitable hydroxyalkyl carbamate compounds include, without limitation, hydroxyethyl carbamate, hydroxypropyl carbamate, hydroxybutyl carbamate, C-36 dimer alcohol monocarbamate, and diethyloctane diol monocarbamate (DEOD monocarbamate).

The coating composition may include one or more further components with carboxylic acids, carbamate, epoxide, or hydroxyl groups. Examples of such further components include, without limitation, neodecanoic acid, glycidyl ester of neodecanoic acid, hydroxystearic acid, fatty acids having 8 to 18 carbon atoms, dimer fatty acids, trimer fatty acids, fatty alcohols having 8 to 18 carbon atoms, dimer fatty alcohols, trimer fatty alcohols, and combinations of these, which may be added to impart flexibility to the coating, if desired.

The thermosetting coating composition cures via at least three different reactions. Reactions involve reactions between crosslinkable functional groups and crosslinkers and may be include addition polymerization of polymerizable unsaturation, and/or moisture cure. One kind of crosslinkable functional group of the crosslinkable materials may be reactive with more than one type of crosslinker in the composition, and one type of crosslinker may be reactive with more than one crosslinkable functional group of the crosslinkable materials in the composition. The thermosetting coating composition may be a one-component (1K) composition, or certain reactive species may be separated from one another in a two-component (2K) or multiple-component coating composition.

Suitable crosslinkers include, without limitation, aminoplasts, polyisocyanates (which may optionally be blocked), polycarboxylic acids, polyepoxides, beta-hydroxy amides, alkyl silanes. The crosslinker may also be capable of self-condensation, as in the case of alkyl silane, aminoplasts, and polyunsaturates addition polymerizable monomers. The crosslinker or crosslinkers are selected according to the kinds of crosslinkable functional groups present on the crosslinkable materials.

The thermosetting coating compositions further contain crosslinkers selected from crosslinking materials, which may also be selected from polymers, oligomers, or monomeric compounds, that have functional groups reactive with the crosslinkable functional groups of the crosslinkable materials so that the crosslinkable functional groups and the crosslinkers have at least three kinds of mutually reactive combinations. Useful crosslinkers include, without limitation materials having active methylol or methylalkoxy groups, such as aminoplast crosslinking agents or phenol/formaldehyde adducts; curing agents that have isocyanate groups, particularly blocked isocyanate curing agents, curing agents that have epoxide groups, amine groups, acid groups, siloxane groups, cyclic carbonate groups, polyanhydrides (e.g., polysuccinic anhydride), and polysiloxanes (e.g., trimethoxy siloxane). Another suitable crosslinking agent is tris(alkoxy carbonylamino)triazine (available from Cytec Industries under the tradename TACT).

The coating composition in certain embodiments includes an aminoplast as a crosslinker. An aminoplast for purposes of the invention is a material obtained by reaction of an activated nitrogen with a lower molecular weight aldehyde, optionally further reacted with an alcohol (preferably a mono-alcohol with one to four carbon atoms) to form an ether group. Preferred examples of activated nitrogens are activated amines such as melamine, benzoguanamine, cyclohexylcarboguanamine, and acetoguanamine; ureas, including urea itself, thiourea, ethyleneurea, dihydroxyethyleneurea, and guanylurea; glycoluril; amides, such as dicyandiamide; and carbamate functional compounds having at least one primary carbamate group or at least two secondary carbamate groups.

The activated nitrogen is reacted with a lower molecular weight aldehyde. The aldehyde may be selected from formaldehyde, acetaldehyde, crotonaldehyde, benzaldehyde, or other aldehydes used in making aminoplast resins, although formaldehyde and acetaldehyde, especially formaldehyde, are preferred. The activated nitrogen groups are at least partially alkylolated with the aldehyde, and may be fully alkylolated; preferably the activated nitrogen groups are fully alkylolated. The reaction may be catalyzed by an acid, e.g. as taught in U.S. Pat. No. 3,082,180, the contents of which are incorporated herein by reference.

The alkylol groups formed by the reaction of the activated nitrogen with aldehyde may be partially or fully etherified with one or more monofunctional alcohols. Suitable examples of the monofunctional alcohols include, without limitation, methanol, ethanol, propanol, isopropanol, butanol, isobutanol, tert-butyl alcohol, benzyl alcohol, and so on. Monofunctional alcohols having one to four carbon atoms and mixtures of these are preferred The etherification may be carried out, for example, by the processes disclosed in U.S. Pat. Nos. 4,105,708 and 4,293,692, the disclosures of which are incorporated herein by reference.

It is preferred for the aminoplast to be at least partially etherified, and especially preferred for the aminoplast to be fully etherified. The preferred compounds have a plurality of methylol and/or etherified methylol groups, which may be present in any combination and along with unsubstituted nitrogen hydrogens. Fully etherified melamine-formaldehyde resins are particularly preferred, for example and without limitation hexamethoxymethyl melamine.

The curable coating composition in certain embodiments includes a polyisocyanate or blocked polyisocyanate crosslinker. Useful polyisocyanate crosslinkers include, without limitation, isocyanurates, biurets, allophanates, uretdione compounds, and isocyanate-functional prepolymers such as the reaction product of one mole of a triol with three moles of a diisocyanate. The polyisocyanate may be blocked with lower alcohols, oximes, or other such materials that volatilize at curing temperature to regenerate the isocyanate groups.

An isocyanate or blocked isocyanate is may be used in 0.1-1.1 equivalent ratio, more preferably from 0.5-1.0 equivalent ratio to the amount of functional groups reactive therewith available from the crosslinkable materials.

Optionally, the thermosetting coating compositions may also contain as crosslinkers photoinitiators that, on exposure to actinic radiation, initiate addition polymerization of coosslinkable functional groups of the crosslinkable materials. Nonlimiting examples of suitable photoinitiators include Examples of suitable photoinitiators include, without limitation, benzoin ethers such as benzoin methyl ether, benzoin ethyl ether, benzoin phenyl ether, and so on; alkylbenzoins such as methylbenzoin, ethylbenzoin, and so on; benzyl derivatives including benzyldimethylketal; 2,4,5-triarylimidazole dimers including 2-(o-chlorophenyl)-4,5-diphenylimidazole dimer, 2-(o-chlorophenyl)-4,5-di(m-methoxyphenyl)imidazole dimer, 2-(o-fluorophenyl)-4,5-phenylimidazole dimer, 2-(o-methoxyphenyl)-4,5-diphenylimidazole dimer, 2-(p-methoxyphenyl)-4,5-diphenylimidazole dimer, 2,4-di(p-methoxyphenyl)-5-phenylimidazole dimer, 2-(2,4-dimethoxyphenyl)-4,5-diphenylimidazole dimer, and so on; acridine derivatives such as 9-phenylacridine and 1,7-bis(9,9′-acridinyl)heptane; N-phenylglycine; aromatic ketones such as trimethylbenzophenone, isopropylthioxanthone, benzophenone, 2-chloro and 2-ethyl-thioxanthone, 2,2-dimethoxy-2-phenylacetophenone, 2,2-diethoxyacetophenone, 2-hydroxy-2-methyl-1-phenyl-propanone, oligo-[2-hydroxy-2-methyl-1-[4-(1-methylvinyl)phenyl]propanone, 1-hydroxycyclohexyl-acetophenone, and 2-ethyl-hydroquinone; phosphine oxides, such as 2,4,6-trimethylbenzoyldiphenylphosphine oxide, and combinations of these.

Pigments and fillers may be utilized in amounts typically of up to about 40% by weight, based on total weight of the coating composition. The pigments used may be inorganic pigments, including metal oxides, chromates, molybdates, phosphates, and silicates. Examples of inorganic pigments and fillers that could be employed are titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium ferrocyanide (Prussian blue), ultramarine, lead chromate, lead molybdate, and mica flake pigments. Organic pigments may also be used. Examples of useful organic pigments are metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, and the like. The coating composition may include a catalyst to enhance the cure reaction. Such catalysts are well-known in the art and include, without limitation, zinc salts, tin salts, blocked para-toluenesulfonic acid, blocked dinonylnaphthalenesulfonic acid, or phenyl acid phosphate. The coating composition used in the practice of the invention may include a catalyst to enhance the cure reaction. For example, when aminoplast compounds, especially monomeric melamines, are used as a curing agent, a strong acid catalyst may be utilized to enhance the cure reaction. Such catalysts are well-known in the art and include, without limitation, p-toluenesulfonic acid, dinonylnaphthalene disulfonic acid, dodecylbenzenesulfonic acid, phenyl acid phosphate, monobutyl maleate, butyl phosphate, and hydroxy phosphate ester. Strong acid catalysts are often blocked, e.g. with an amine. Other catalysts that may be useful in the composition of the invention include Lewis acids, zinc salts, and tin salts.

A solvent or solvents may be included in the coating composition. In general, the solvent can be any organic solvent and/or water. In one preferred embodiment, the solvent includes a polar organic solvent. More preferably, the solvent includes one or more organic solvents selected from polar aliphatic solvents or polar aromatic solvents. Still more preferably, the solvent includes a ketone, ester, acetate, or a combination of any of these. Examples of useful solvents include, without limitation, methyl ethyl ketone, methyl isobutyl ketone, m-amyl acetate, ethylene glycol butyl ether-acetate, propylene glycol monomethyl ether acetate, xylene, N-methylpyrrolidone, blends of aromatic hydrocarbons, and mixtures of these. In another preferred embodiment, the solvent is water or a mixture of water with small amounts of co-solvents. In general, protic solvents such as alcohol and glycol ethers are avoided when the coating composition includes the optional polyisocyanate crosslinker, although small amounts of protic solvents can be used even though it may be expected that some reaction with the isocyanate groups may take place during curing of the coating.

Additional agents, for example hindered amine light stabilizers, ultraviolet light absorbers, anti-oxidants, surfactants, stabilizers, wetting agents, rheology control agents, dispersing agents, adhesion promoters, etc. may be incorporated into the coating composition. Such additives are well-known and may be included in amounts typically used for coating compositions.

The coating compositions can be coated on a substrate by spray coating. Electrostatic spraying is a preferred method. The coating composition can be applied in one or more passes to provide a film thickness after cure of typically from about 20 to about 100 microns.

The coating composition can be applied onto many different types of substrates, including metal substrates such as bare steel, phosphated steel, galvanized steel, or aluminum; and non-metallic substrates, such as plastics and composites. The substrate may also be any of these materials having upon it already a layer of another coating, such as a layer of an electrodeposited primer, primer surfacer, and/or basecoat, cured or uncured.

After application of the coating composition to the substrate, the coating is cured, preferably by exposing the coating layer to heat, water (for moisture cure) and/or actinic radiation for a length of time sufficient to cause the reactants to form an insoluble polymeric network. The cure temperature is usually from about 105° C. to about 175° C., and the length of cure is usually about 15 minutes to about 60 minutes. Preferably, the coating is cured at about 120° C. to about 150° C. for about 20 to about 30 minutes. Heating can be done in infrared and/or convection ovens.

In one embodiment, the coating composition is utilized as the clearcoat of an automotive composite color-plus-clear coating. The pigmented basecoat composition over which it is applied may be any of a number of types well-known in the art, and does not require explanation in detail herein. Polymers known in the art to be useful in basecoat compositions include acrylics, vinyls, polyurethanes, polycarbonates, polyesters, alkyds, and polysiloxanes. Preferred polymers include acrylics and polyurethanes. In one preferred embodiment of the invention, the basecoat composition also utilizes a carbamate-functional acrylic polymer. Basecoat polymers may be thermoplastic, but are preferably crosslinkable and comprise one or more type of crosslinkable functional groups. Such groups include, for example, hydroxy, isocyanate, amine, epoxy, acrylate, vinyl, silane, and acetoacetate groups. These groups may be masked or blocked in such a way so that they are unblocked and available for the crosslinking reaction under the desired curing conditions, generally elevated temperatures. Useful crosslinkable functional groups include hydroxy, epoxy, acid, anhydride, silane, and acetoacetate groups. Preferred crosslinkable functional groups include hydroxy functional groups and amino functional groups.

Basecoat polymers may be self-crosslinkable, or may require a separate crosslinking agent that is reactive with the functional groups of the polymer. When the polymer comprises hydroxy functional groups, for example, the crosslinking agent may be an aminoplast resin, isocyanate and blocked isocyanates (including isocyanurates), and acid or anhydride functional crosslinking agents.

The clearcoat coating composition of this invention is generally applied wet-on-wet over a basecoat coating composition as is widely done in the industry. The coating compositions described herein are preferably subjected to conditions so as to cure the coating layers as described above.

The coating composition of the invention may also be utilized as a basecoat coating. A basecoat coating composition includes one or more of the pigments mentioned above, and provides the color and/or metallic effect to a basecoat/clearcoat composite coating. A basecoat coating of the invention may be used with a clearcoat coating composition such as those described in the art, including those containing film forming materials with hydroxyl, carboxyl, epoxide, and/or carbamate groups and crosslinkers including aminoplasts, polyisocyanates, polyepoxides, and polycarboxylic acids.

A particular example of our coating composition includes an acrylic or vinyl polymer having carboxyl, hydroxyl, and carbamate groups and, as crosslinker, an aminoplast, a polyisocyanate (free or blocked) and a polyepoxide. Additional materials such as long-chain dicarbamates such as those mentioned above or other such carbamate-functional materials such as those described in U.S. Pat. No. 6,914,096, 6,900,270, and 6,362,285 may also be used.

Another particular example of our coating composition includes an acrylic or vinyl polymer having epoxide, hydroxyl, and carbamate groups and, as crosslinker, an aminoplast, a polyisocyanate (free or blocked) and a polycarboxyl crosslinker.

Another particular example of our coating composition includes as one component a moisture-curable polymer having at least one silane group.

A further particular example of our coating composition includes a polyisocyanate reacted with one or more materials selected from compounds with hydroxyl and carboxyl groups, compounds with secondary and primary hydroxyl groups, compounds or oligomers with hydroxyl and carbamate groups, compounds and oligomers with acrylate groups and hydroxyl groups, and compounds with amine groups and silane groups, The proportion of reactants may be controlled so as to leave isocyanate functionality in the product material. The product material is then combined with one or more suitable crosslinkers or used as a crosslinkable material in the coating composition.

Yet another particular example of our coating composition includes a polyepoxide material, such as triglycidylisocyanurate, reacted with one or more materials selected from compounds with hydroxyl and carboxyl groups, compounds with carboxyl and carbamate groups, acrylic acid, and carboxyl-functional alkoxysilanes. The proportion of reactants may be controlled so as to leave epoxide functionality in the product material. The product material is then combined with one or more suitable crosslinkers or used as a crosslinkable material in the coating composition.

A further particular example of our coating composition includes an aminoplast resin that has been reacted with one or more materials selected from compounds and oligomers with hydroxyl and carbamate groups, alkylcarbamate acrylates, and alkoxysilane carbamates. The proportion of reactants may be controlled so as to leave residual aminoplast functionality (that is, amino, aminoalkoxy, or aminoalkanol functionality in the product material. The product material is then combined with one or more suitable crosslinkers or used as a crosslinkable material in the coating composition.

The composition may include one crosslinkable material with two or more kinds of crosslinkable groups and a plurality of crosslinkers (including water in the case of moisture cure and photoinitiators in the case of addition polymerizable material), which engage in at least three crosslinking reactions. In one embodiment, the crosslinkable material has three kinds of crosslinkable groups, each of which react with a separate kind of three kinds of crosslinkers in the composition. In another embodiment, the crosslinkable material has three kinds of crosslinkable groups, two of which react with a first kind of crosslinker in the composition and a third kind of crosslinkable group that reacts with a second kind of crosslinker in the composition.

The composition may include two or more crosslinkable materials, one of which has two or more kinds of crosslinkable groups, and one of which has still a different kind of crosslinkable groups. The composition may include one crosslinker that is reactive with at least three kinds of crosslinkable groups, or may include at least two crosslinkers reactive with different kinds of the crosslinkable groups. If the composition includes two crosslinkers, then one must be reactive with at least two different kinds of crosslinkable groups.

The composition may also include at least three crosslinkable materials, each of which carries a different kind of crosslinkable group. In this case, the composition may include a different crosslinker for each kind of crosslinkable group, or it may include two different kinds of crosslinker, one of which is reactive with two or more kinds of crosslinkable groups present, or it may include a single crosslinker reactive with all of the different kinds of crosslinkable groups present.

The invention is further described in the following examples. The examples are merely illustrative and do not in any way limit the scope of the invention as described and claimed. All parts are parts by weight unless otherwise noted.

Preparation 1

A reactor containing 1300 parts by weight of amyl acetate is heated under an inert atmosphere until the solvent is at 140° C. Then, a mixture of 480 parts by weight of 2-(carbamyloxy)ethyl methacrylate, 480 parts by weight of 2-hydroxyethyl methacrylate, 720 parts by weight of glycidyl methacrylate, 720 parts by weight of 2-ethylhexyl acrylate, and 192 parts by weight of 2,2′-dimethyl-2,2′-azodibutyronitrile is added over a four hour period. Then 30 parts by weight of amyl acetate are added and the reaction mixture is held at 140° C. for one hour. The resin will have about 65% by weight nonvolatiles, have a hydroxy equivalent weight of 675 g/equ, have an epoxy equivalent weight of 490 g/equ, and have a carbamate equivalent weight of 900 g/equ.

Preparation 2

A reactor containing 1180 parts by weight of butyl acetate and 2500 parts by weight of the isocyanurate of isophorone diisocyanate is heated under an inert atmosphere until the solvent is at 50° C. Then, 2.2 parts by weight of dibutyl tin dilaurate is added, followed by a slow addition of 407.1 parts by weight of 2-hydroxyisobutyric acid. The reaction temperature is not allowed to go above 75° C. during this add. Once all of the acid has been added, the temperature is held at 75° C. until the isocyanate equivalent weight on nonvolatile material is 416 g/equ. The resin will have about 70% by weight nonvolatiles, have an acid equivalent weight of 843 g/equ, and have an isocyanate equivalent weight of 416 g/equ.

Preparation 3

A mixture of 914 parts by weight of CYMEL® 303 melamine resin (available from Cytec Industries, Stamford, Conn.), 826.8 parts by weight of hdyroxypropyl carbamate, and 1000 parts by weight of methanol is heated to 69° C. under an inert atmosphere. Then, 12 parts by weight of dodecylbenzene sulfonic acid is added, and the reaction mixture is held under 70° C. until all of the hydroxypropyl carbamate is incorporated into the melamine resin. Next, 340 parts by weight of maleic anhydride is added and the reaction again held under 70° C. until all of the anhydride has been reacted. The temperature is lowered to 45° C. and the methanol by-product removed by vacuum distillation. During the distillation the temperature of the reaction mixture is allowed to drop to 30° C. The product has an aminoplast equivalent weight of 300 g/equ., an hydroxy equivalent weight of 600 g/equ, an acid equivalent weight of 600 g/equ, and a free radical activatable double bond equivalent weight of 600 g/equ.

### EXAMPLE 1 OF THE INVENTION

A coating composition is prepared by mixing together 100 parts by weight of the resin of Preparation 1,160 parts by weight of the resin of Preparation 2, 40 parts by weight of the resin of Preparation 3, and 1 part by weight of dibutyl tin diacetate. The mixture is reduced with 40 parts by weight of isobutanol. The coating composition is drawn down on a glass plate and heated for 30 minutes at 285° F. to make a cured coating layer.

### EXAMPLE 2 OF THE INVENTION

A coating composition is prepared as in Example 1 of the invention, but a photoinitiator (2,4,6-trimethylbenzophenone) is incorporated in the coating composition. The coating composition is drawn down on a glass plate, exposed to UV light, and heated for 30 minutes at 285° F. to make a cured coating layer.

The description of the embodiments of the invention is merely exemplary in nature and, thus, many variations not specifically described are intended to be within the scope of the invention. Such variations are not to be regarded as a departure from the spirit and scope of the invention.

What is claimed is:

1. A thermosetting coating composition, comprising:
(a) one or more crosslinkable materials that have at least two kinds of crosslinkable functional groups and
(b) one or more crosslinkers that have functional groups reactive with the crosslinkable functional groups of the crosslinkable materials and, optionally photoinitiators that, on exposure to actinic radiation, initiate addition polymerization of crosslinkable functional groups of the crosslinkable materials,
wherein the crosslinkable functional groups and the crosslinkers have at least three kinds of mutually reactive combinations.

2. A thermosetting coating composition, comprising
(a) at least three kinds of crosslinkable functional groups on one or more crosslinkable materials and
(b) one or more crosslinkers reactive with the at least three kinds of crosslinkable functional groups.

3. A thermosetting coating composition, comprising
(a) a crosslinkable component comprising an addition polymerizable material and one or more further materials comprising two or more kinds of crosslinkable functionalities other than addition polymerizable groups,
(b) a photoinitiator,
(c) one or more crosslinkers reactive with the crosslinkable functionalities of the one or more further materials.

4. A thermosetting coating composition, comprising
(a) a first crosslinkable material having two different kinds of crosslinkable functional groups,
(b) a second crosslinkable material having a third kind of crosslinkable functional group different from the crosslinkable functional groups of the first crosslinkable material, and
(c) one or more crosslinkers reactive with the crosslinkable functionalities of the first and second crosslinkable materials.

5. A thermosetting coating composition, comprising
(a) one or more crosslinkable materials that have at least three kinds of crosslinkable functional groups and
(b) a plurality of crosslinkers reactive with the at least three kinds of crosslinkable functional groups, each of which is reactive with only one kind of the crosslinkable functional groups.

6. A thermosetting coating composition, comprising
(a) one or more crosslinkable materials that have at least three kinds of crosslinkable functional groups and
(b) a plurality of crosslinkers reactive with the at least three kinds of crosslinkable functional groups, each of which is reactive with at least two kinds of the crosslinkable functional groups.

7. A thermosetting coating composition, comprising
(a) one crosslinkable material that has at least three kinds of crosslinkable functional groups and
(b) one or more crosslinkers reactive with each of the at least three kinds of crosslinkable functional groups.

8. A thermosetting coating composition according to claim 7, wherein the one crosslinkable material is an acrylic or vinyl polymer having carboxyl, hydroxyl, and carbamate groups.

9. A thermosetting coating composition according to claim 7, wherein the one crosslinkable material is an acrylic or vinyl polymer having epoxide groups, hydroxyl groups, and carbamate groups.

10. A thermosetting coating composition according to claim 7, wherein the one crosslinkable material comprises at least one silane group.

11. A thermosetting coating composition according to claim 7, wherein the one crosslinkable material comprises a polyisocyanate material reacted with materials selected from compounds with hydroxyl and carboxyl groups, compounds with secondary and primary hydroxyl groups, compounds or oligomers with hydroxyl and carbamate groups, compounds and oligomers with acrylate groups and hydroxyl groups, and compounds with amine groups and silane groups,

12. A thermosetting coating composition according to claim 11, wherein the crosslinkable material comprises isocyanate groups.

13. A thermosetting coating composition according to claim 7, wherein the one crosslinkable material comprises a polyepoxide material reacted with materials selected from compounds with hydroxyl and carboxyl groups, compounds with carboxyl and carbamate groups, acrylic acid, and carboxyl-functional alkoxysilanes.

14. A thermosetting coating composition according to claim 13, wherein the crosslinkable material comprises epoxide groups.

15. A thermosetting coating composition according to claim 13, wherein the polyepoxide is triglycidylisocyanurate.

16. A thermosetting coating composition according to claim 7, wherein the one crosslinkable material comprises an at least tri-functional aminoplast material reacted with materials selected from compounds and oligomers with hydroxyl and carbamate groups, alkylcarbamate acrylates, and alkoxysilane carbamates.

17. A thermosetting coating composition according to claim 16, wherein the one crosslinkable material has residual aminoplast functionality.
